(19) United States
(12) Patent Application Publication
(10) Pub. No.: US 2002/0100755 A1
(43) Pub. Date: Aug. 1, 2002

(54) Microwave cooking bag with transparent (see-through) panels

(76) Inventor: Darius Fonternez Peterson, McDonough, GA (US)

Correspondence Address: Darius F. Peterson, SR., 264 McKinley Loop, McDonough, GA, 30253, US

(21) Appl. No.: 09/954,106

(22) Filed: Sep. 17, 2001

Related U.S. Application Data
(60) Provisional application No. 60/233,359, filed on Sep. 18, 2000.

(51) Int. Cl. H05B 6/80

(52) U.S. Cl. 219/727; 219/730; 426/234

(57) ABSTRACT

Invention concerns microwaveable bags used to store and cook food products such as microwave popcorn and the like. Given a microwave cooking bag with transparent (see-through) panels. The package generally comprises inner and outer plies of flexible material, such as paper, bonded or adhered to one another, with a microwave interactive construction in between. Additionally, a see-through heat-resistant, anti-fogging, heat-sealable, microwaveable, shelf-stable panel is integrated or bonded to the outer layer of the bag to facilitate viewing of the contents within the package such as popcorn while it is cooking.

### CROSS-REFERENCE TO RELATED APPLICATIONS

This application claims the benefit of Provisional Patent Application 60/233,359 filed on Sep. 18, 2000 (filing receipt OC000000005674617).

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF INVENTION

This application claims the benefit of Provisional Patent Application 60/233,359 filed on Sep. 18, 2000 (filing receipt OC000000005674617).

By far, one of the most popular snacks in the world is popcorn—especially microwaveable brands. The snack is quick, convenient, and can be served piping hot in a matter of minutes. It is also self-contained for easy clean-up and disposal in a unique cooking bag. These pliable bags are specially treated and designed to withstand the microwave cooking process. They are heat and flame resistant with the ability to expand to accommodate the finished product. Furthermore, they are leak and stain proof for storage purposes.

Although microwaveable popcorn and related products are in high demand, at least one common problems exists. Because of the varying types of microwaves and power outputs, the cooking process is a guess at best. It normally takes anywhere between 2 minutes and thirty seconds to 4 minutes of more to fully cook a bag of popcorn. This minute or so difference can mean the difference between a good product or a bad one. Whether the product is undercooked (many kernels left un-popped) or overcooked (burned), the result is the same—dissatisfied customers. The waste of the un-cooked kernels and the smell of burned popcorn blanketing an office leaves a negative image with consumers and stymies a desire for the product.

To overcome the myriad of disadvantages posed by the current microwave popcorn/food packages or bags on the market, my invention overwhelmingly enhances and revolutionizes the process. My invention comprises a microwave cooking bag with see-through panels. A panel is synonymous with a particular geometric side or portion of the bag. These see-through panels will allow the consumer to observe the product prior to cooking or microwaving to ensure there are no foreign objects, debris, or contaminated products within the package. Additionally the consumer can monitor the microwave cooking or popping process from start to finish. By being able to observe the cooking process, the quality of the finished product is placed in the hands of the consumer and not solely in the microwave's power output and timer. Based on what the product looks like through the see-through panel, the consumer can interrupt or prolong the microwave process as he or she sees fit.

### BRIEF SUMMARY OF INVENTION

Currently, there are several patents relating to the microwave popcorn cooking process including the following numbers: U.S. Pat. Nos. 4,904,487; 4,904,488; 4,963,374; 6,060,096; 6,083,552. Many of these patents or processes are the norms and allow for the successful microwaving of popcorn because of their specially treated and designed microwaveable bags. However, these bags do not allow the customer to observe the popcorn cooking process. My idea improves the current arrangement by adding see-through, mylar-like, anti-fogging, heat and stain-resistant, microwaveable, panels integrated with current bag features of the specially treated pliable microwave bag. A panel is synonymous with a particular geometric side or portion of a bag. Additionally, the new bag is also stain and leak proof, expandable, and capable of providing a stable shelf-life for the product. Transparent or see-through (mylar)panels can be used at strategic vantage points.

### BRIEF DESCRIPTION OF SEVERAL VIEWS OF DRAWING

FIG. 1 is a perspective frontal view of an opaque, microwave bag construction currently in use according to present industry standards and instructions—it is depicted with parts assignments: Panel A (outer frontal layer of bag which faces top of microwave during cooking/popping), Panel C (left portion of bag when Panel A faces upward), Panel D (right portion of bag when Panel A faces upward), Panel E (bottom end or base of bag used for standing bag upright) Panel F (top end of bag used to access food product).

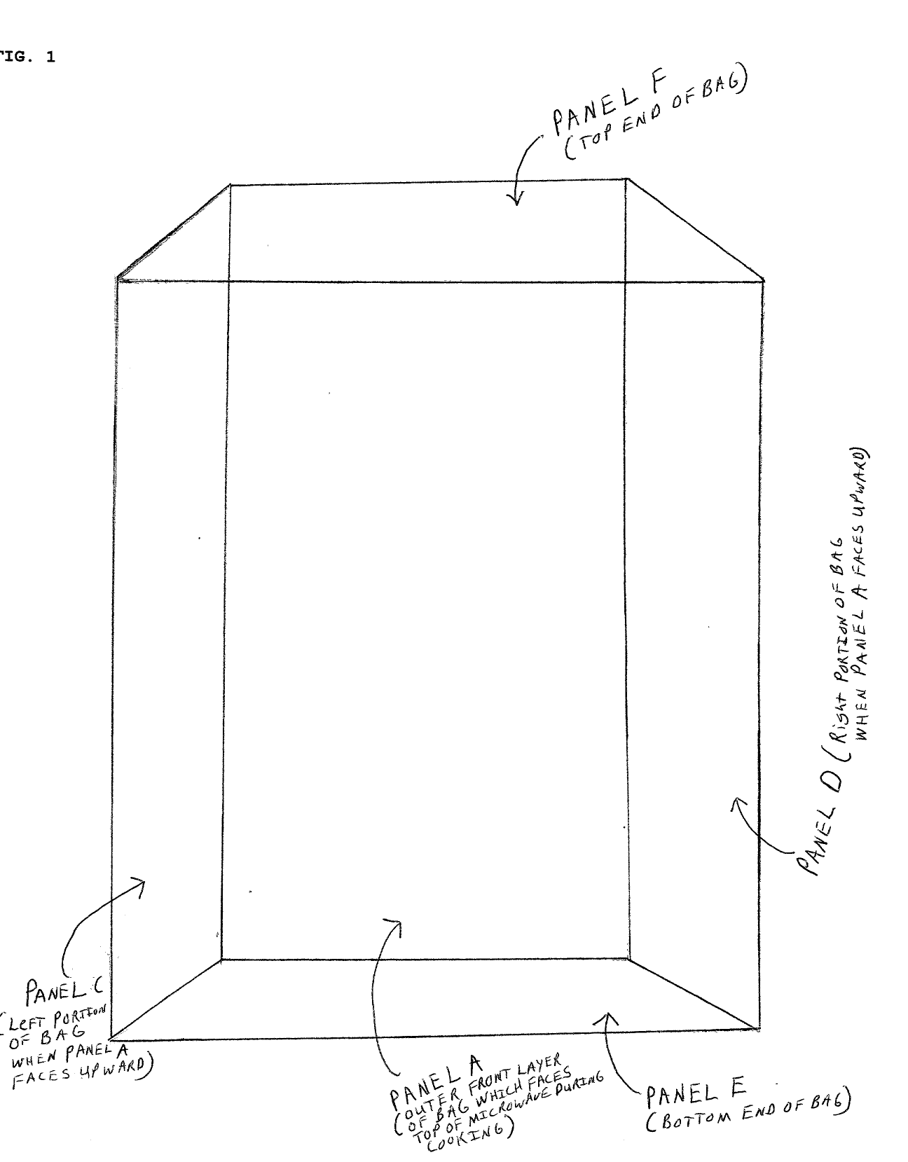

FIG. 2 Perspective rear view of the arrangement depicted in FIG. 1 shown with parts assignment: Panel B (outer rear layer of bag which contains the microwave susceptor and faces downward in the microwave thus making contact with the microwave surface).

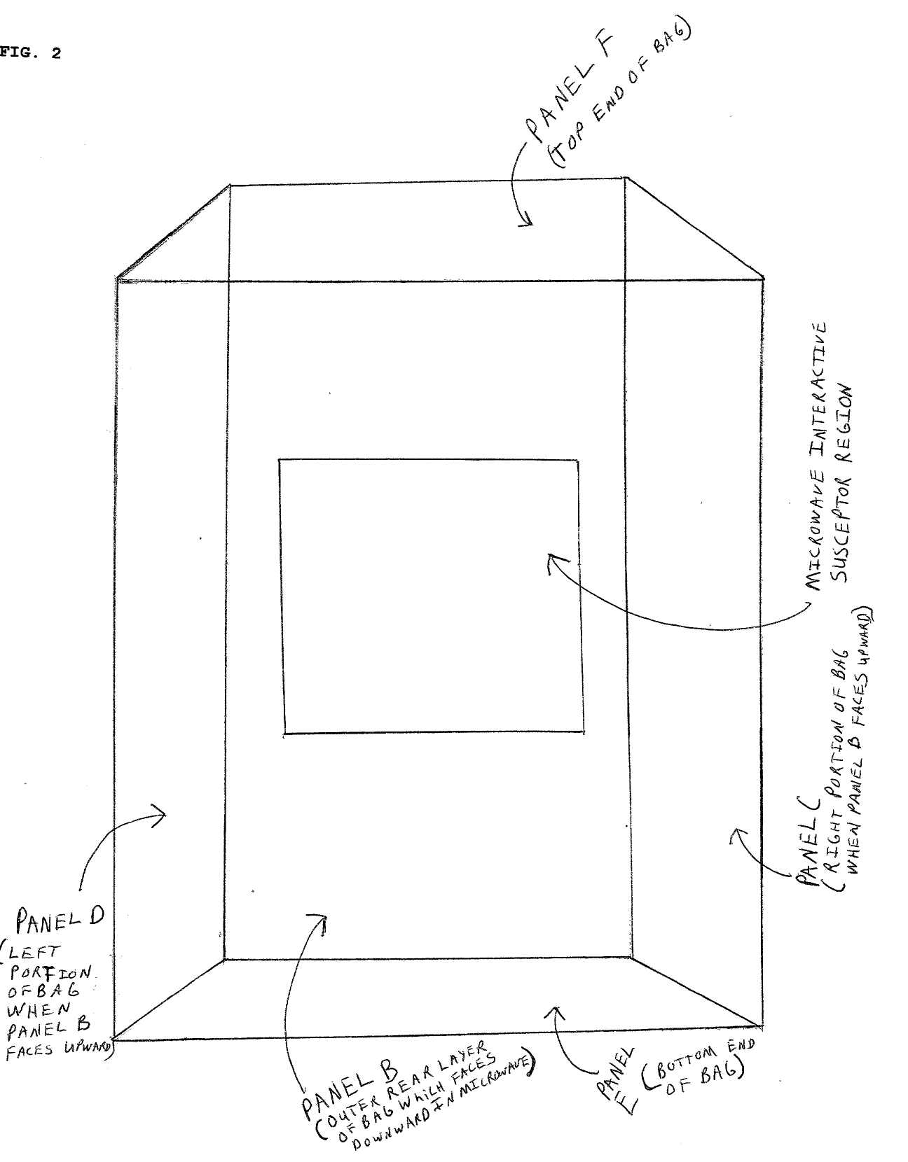

FIG. 3 is a perspective frontal view of improved invention bag with the addition of transparent strips on Panels C and D to enable viewing of food product during microwave process.

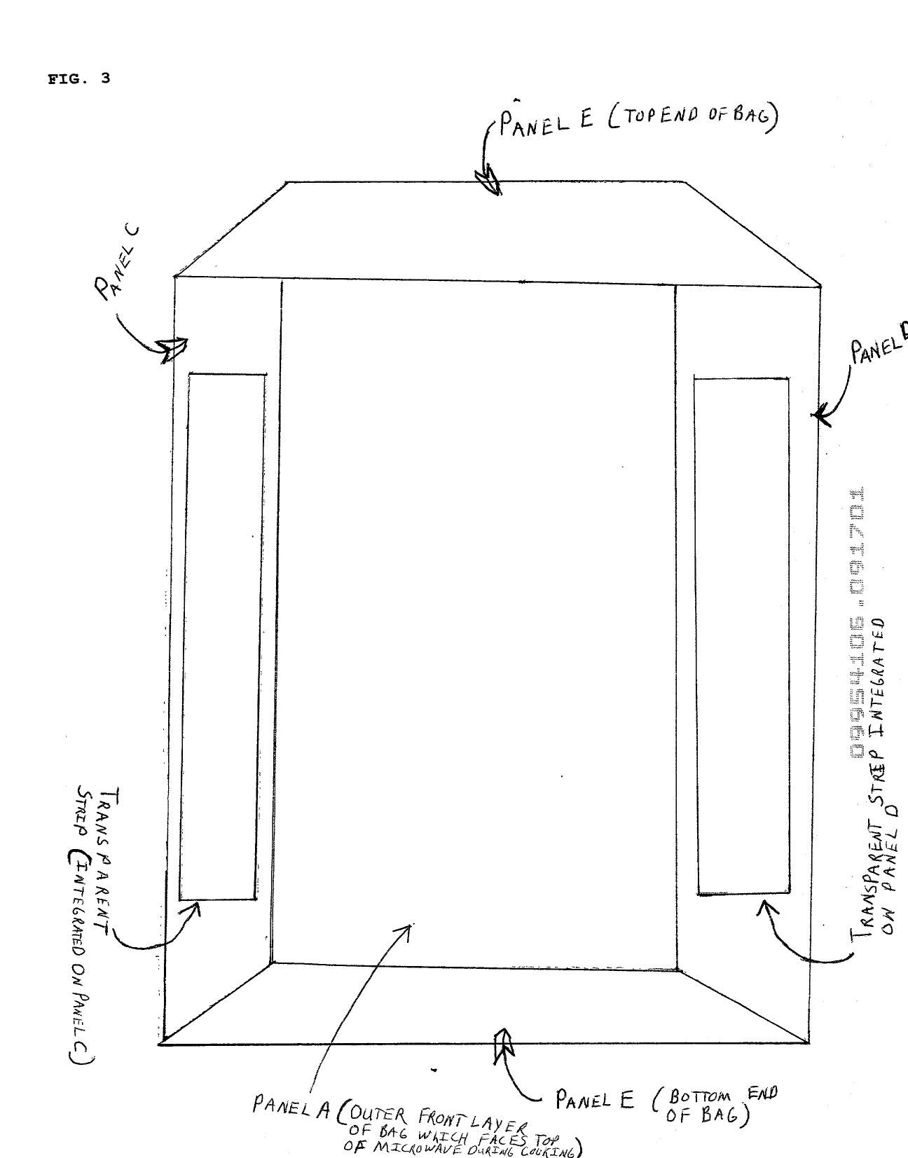

FIG. 4 Perspective frontal, top, bottom, and left side view of current industry opaque bags.

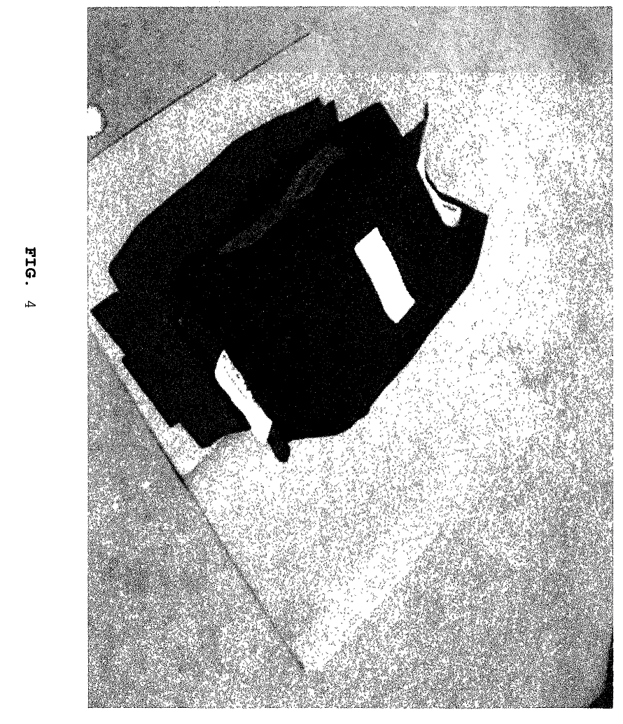

FIG. 5 is a perspective horizontal view of arrangement depicted in FIG. 4.

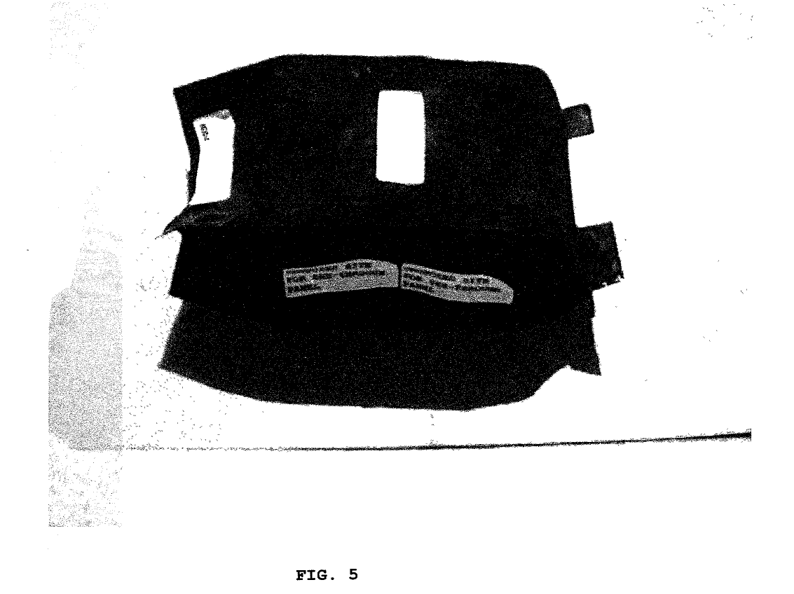

FIG. 6 is vertical view of the arrangement depicted in FIG. 4.

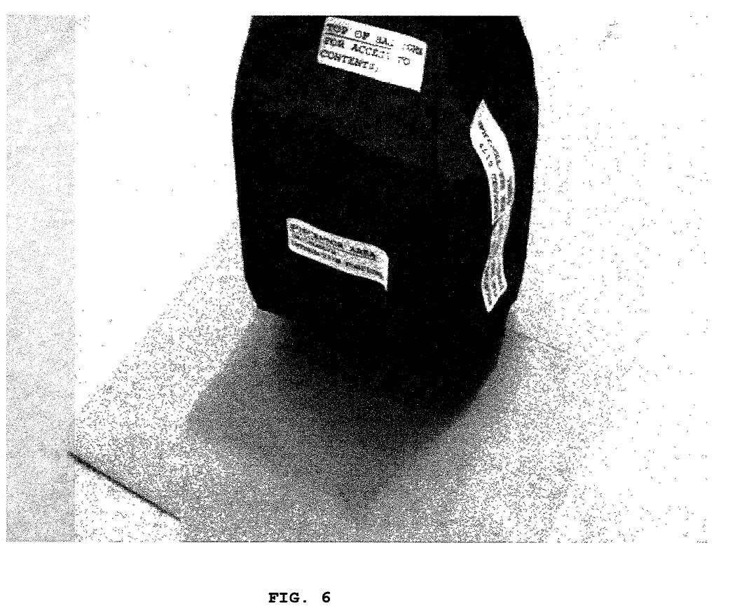

FIG. 7 Perspective top view of new invention bag displaying Panels A, C, E, and F—Panel C depicts a transparent strip for viewing cooked popcorn.

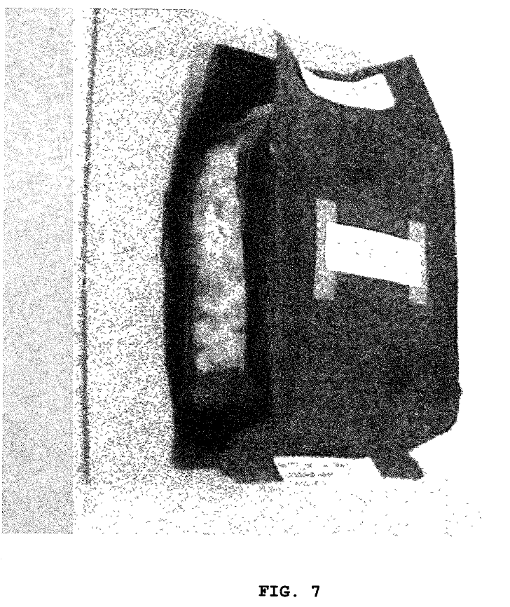

FIG. 8 Perspective top-end view (panel F) of arrangement depicted in FIG. 7—Panel D depicts a transparent strip for viewing cooked popcorn.

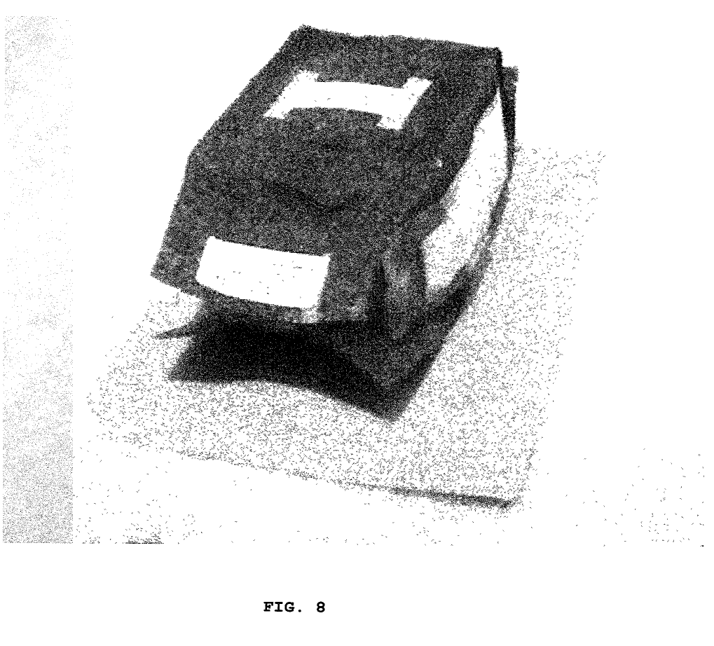

FIG. 9 is an exploded view of Panel D depicted in the arrangement in FIG. 8.

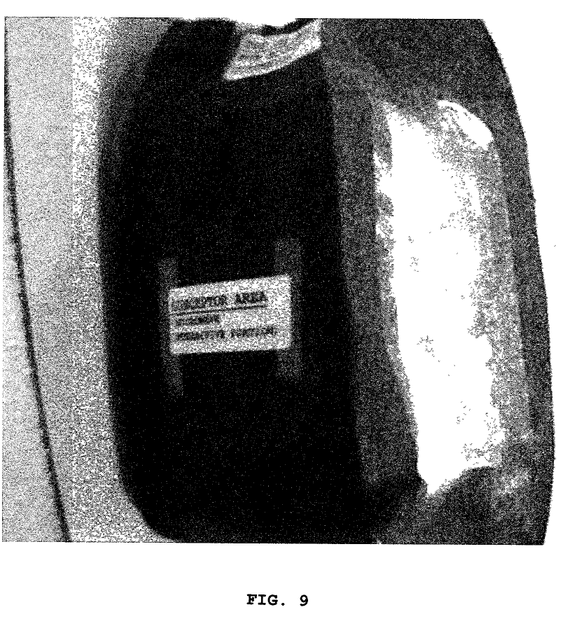

FIG. 10 a vertical view of the arrangement depicted in FIG. 7.

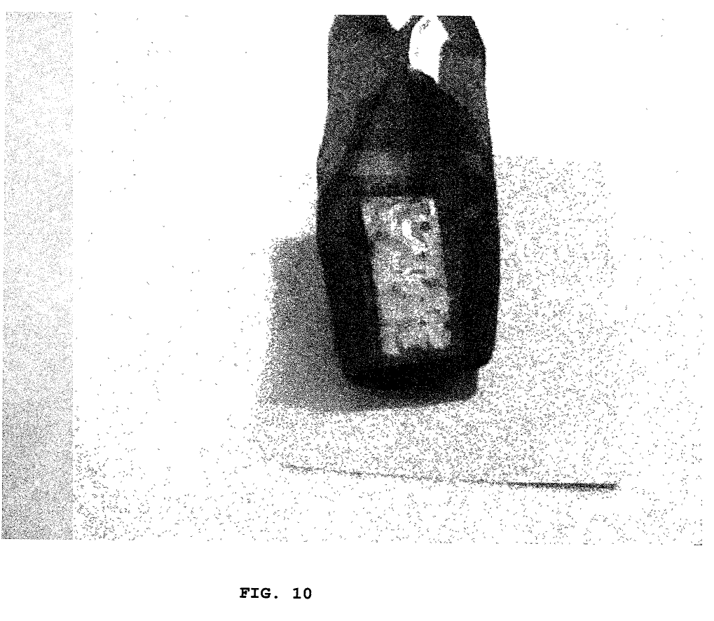

### DETAILED DESCRIPTION OF THE INVENTION

In general, conventional microwave cooking packages or bags comprise two-ply systems, with laminating adhesive applied there between. Generally the laminating adhesive is applied over the entire space, between the two plies. This current package or bag construction provides some distinct disadvantages. For example, the product or contents within the package cannot be viewed by the customer before or during the microwave cooking process. Thus relegating the entire cooking process to the consumer, microwave ovens of varying power outputs, and random chance. Because of this current process several popcorn packages cooked out of every 10 attempted can potentially lead to customer dissatisfaction. This dissatisfaction can be caused by the cooking process producing an undercooked product (many kernels left un-popped) or an overcooked product whereby the product is partially or severely burned during the cooking process leaving the home, office, or facility used to cook it smelling like burned popcorn or other food producing a negative impact on customers and potential customers. Either way, under-cooked or over-cooked popcorn leads to one result-dissatisfied customers.

Along the same line, if the product is contaminated from the source or during shipment with either foreign debris, material, germs, bacteria, or the like it cannot be detected until the contents are cooked or someone eats it and becomes ill from its the effects of ingestion. Integrating see-through panels into the bag manufacturing process will alleviate this prospect.

Finally, as with any product on the market, is innovative packaging. In order to attract new customers and retain the old ones businesses must appeal to the eye of the customer. Although many microwave packages or bags have evolved over the past 20 or 30 years, one fact remains the same—they are all opaque in nature. In other words, customers can't see through them hence companies are placing better food products into old, archaic, drab looking packages or bags with no sign of innovation. A new millennium calls for a new mind-set in product packaging.

Current bags containing see-through windows are used primarily for temporarily storing and transporting food products i.e. pastries or meat products. Traditionally they are not microwaveable, shelf-stable, heat-resistant, or fog-resistant. Although, U.S. Pat. No. 6,033,114 assigned to Bagcraft is ovenable, microwaveable, heat-resistant, and anti-fogging, it also is primarily used for displaying and transporting food products such as meat products and the like. However, the bag is not designed to accommodate the dynamics of expanding to withstand the microwave or the change in size of the package's contents once cooked i.e. popped popcorn, pork rinds and the like. It is not shelf stable for storing various snack foods over extended periods of time. Additionally one end is open so deli or diner personnel can place food into the package and the customer has easy access to the contents when ready to consume. It is not designed to contain contents that have expanded during the microwave cooking process.

CLAIMS

See enclosed CLAIMS page

ABSTRACT OF THE DISCLOSURE

See enclosed ABSTRACT page

DRAWINGS (WHEN NECESSARY)

See enclosed DRAWINGS

OATH OR DECLARATION

See Enclosed DECLARATION form

What is claimed is:

1. A microwave cooking bag with transparent (see-through) panels comprising:
(a) a pliable, flexible bag construction comprising inner and outer plies with each ply having an inner surface and an outer surface, said bag construction having a first portion and a second portion;
(b) said inner and outer plies comprise a laminate depicting rectangularshaped panels possessing opposite ends, said laminate including a thin transparent (see-through)layer formed of a heat-resistant, heat-sealable, moisture-proof,anti-fogging, microwaveable, shelf-stable, mylar-like material and a relatively thicker and stiffer opaque outer layer formed of a foldable material affixed to said inner layer and covering said inner layer except along a transparent panel strip portions of said inner layer extending partially, over said panel structure, said panel portions having uncovered and breathable surfaces sized to permit the passage of heated moisture from the interior of bag to the exterior of the bag in quantities which prevent substantial fogging of the transparent panel portion;
(c) a centralized microwave interactive construction overlap section is located within the said first portion;
(d) a microwave interactive construction strategically placed between said inner and outer plies within said centralized microwave interactive construction overlap section; said microwave interactive construction possessing a front and a back side; and
(e) said inner ply is bonded to said outer ply within stated first portion by adhesive material,

2. The bag of claim 1, wherein said transparent panel strips are rectangular in shape.

3. The bag of claim 2 wherein said bag comprises front and rear panels, joined by side panels, said transparent strip portions being located on both side panels—panels C and D.

4. A microwave cooking bag with transparent (see-through) panels according to claim 1 wherein said second portion comprises an outer boundary around an outer perimeter of one of said inner and outer plies.

5. A microwave cooking bag with transparent (see-through) panels according to claim 1 wherein said centralized microwave interactive construction overlap region comprises a geometric pattern.

6. A microwave cooking bag with transparent (see-through) panels comprising a geometric, continuous pattern of adhesive throughout to bond and secure entire arrangement.

7. A microwave cooking bag with transparent (see-through) panels according to claim 1 wherein:
(a) said geometric pattern is a regular geometric pattern.

8. A microwave cooking bag with transparent (see-through) panels according to claim 7 wherein:
(a) said geometric pattern is arrayed in squares.

9. A microwave cooking bag with transparent (see-through) panels according to claim 1 wherein:
(a) said back side of stated microwave interactive construction comprises a polymer; and
(b) said back side of stated microwave interactive construction is adjacent said inner surface of said outer ply in stated first portion.

10. A microwave cooking bag with transparent (see-through) panels according to claim 1 wherein said back side of said microwave interactive construction is bonded to said outer ply within said microwave interactive overlap region by an adhesive material.

11. A microwave cooking bag with transparent (see-through) panels comprising:
(a) a pliable, flexible, bag construction comprising inner and outer plies, said bag construction including first and second opposite panels joined by first and second opposite side gussets, and two fold lines, and said bag construction having a first portion and a second portion;
(b) a microwave interactive construction positioned between said inside and outside plies within said first portion; and

12. A microwave cooking bag with transparent (see-through) panels according to claim 1 wherein:
(a) said microwave interactive construction comprises a layer of pliable, flexible microwave transparent polymeric material and a field of microwave interactive metallic material positioned and affixed thereon; and
(b) said layer of flexible microwave transparent polymeric material is adjacent said outer ply.

13. A microwave cooking bag with transparent (see-through) panels comprising:
(a) a flexible bag construction comprising inner and outer plies, said bag construction having a first portion and a second portion;
(b) a microwave interactive overlap region within said first portion;
(c) a microwave interactive construction positioned between said inner and outer plies within said microwave interactive overlap region;
(d) a charge of unpopped popcorn kernels within said pliable, flexible bag construction and strategically arranged upon stated microwave interactive overlap region.

14. A microwave cooking bag with transparent (see-through) panels in accordance with claim 13 wherein:
(a) said charge of unpopped popcorn kernels comprises oil and fat.
